(19) United States
(12) Patent Application Publication
(10) Pub. No.: US 2021/0189035 A1
(43) Pub. Date: Jun. 24, 2021

(54) Acrylate Copolymer and Use Thereof

(71) Applicants: SI Group, Inc., Schenectady, NY (US); SI Group Crios Resinas S.A., Rio Claro (BR)

(72) Inventors: Kelly S. Chichak, Halfmoon, NY (US); Lucas Correia, Rio Claro (BR); Rogério Piccolo, São Carlos (BR)

(21) Appl. No.: 17/117,204

(22) Filed: Dec. 10, 2020

Related U.S. Application Data
(60) Provisional application No. 62/951,361, filed on Dec. 20, 2019.

(51) Int. Cl. C08F 220/12; C08K 5/01; C09K 8/524

(52) U.S. Cl. CPC C08F 220/12; C09K 8/524; C08K 5/01

(57) ABSTRACT

An acrylate copolymer, such as for use in a petroleum composition, is provided. The acrylate copolymer has the following repeating units (A) and (B):

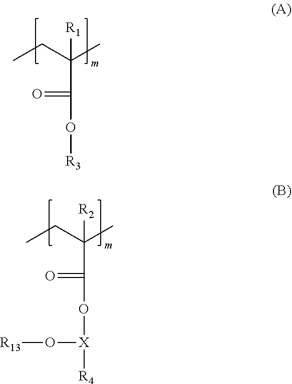

wherein,
R₁ and R₂ are each independently H or a C₁-C₂ alkyl;
R₃ is a C₈-C₅₀ alkyl, a C₈-C₅₀ alkenyl, or a C₈-C₅₀ alkynyl;
X is a divalent radical;
R₄ is a C₄-C₅₀ alkyl, a C₄-C₅₀ alkenyl, a C₄-C₅₀ alkynyl, a C₄-C₁₀ aryl, or —R₅-R₆;
   wherein,
      R₅ is —C(O)O—, —OC(O)—, —C(O)—, —C(O)N(R₁₀)—, —N(R₁₁)C(O)—, —N(R₁₂)—, or —O—;
      R₆ is an alkyl, an alkenyl, an alkynyl, or an aryl; and
      R₁₀, R₁₁, and R₁₂ are each independently H, an alkyl, an alkenyl, or an alkynyl;
R₁₃ is H, an alkyl, an alkenyl, an alkynyl, or an aryl;
m is an integer from 1 to 200; and
n is an integer from 1 to 200.

### RELATED APPLICATIONS

This application claims filing benefit of U.S. Provisional Patent Application No. 62/951,361 having a filing date of Dec. 20, 2019, which is hereby incorporated by reference in its entirety.

### BACKGROUND OF THE INVENTION

Various additives are traditionally employed during oil production to modify the flow properties of a petroleum source or to inhibit the deposition of certain undesirable byproducts onto surfaces. For example, paraffin inhibitors, asphaltene dispersants, and scale inhibitors may be selectively injected into wells or flowlines to treat a petroleum source and prevent or control the effects of precipitation of paraffins, asphaltenes, and mineral scale. These additives can also be used at other points of the oil production cycle, such as during transportation or storage to limit the deposition of solids on the surface of pipes, storage vessels, and transportation vessels (rail cars, ocean tankers, etc.). Unfortunately, certain conventional additives may not perform as well as desired, for example with regard to paraffin inhibition. In addition, because most conventional additives have limited functionality, operators typically need to add multiple different additives to a petroleum source during a production cycle. As such, a need continues to exist for an additive that provides improved performance with respect to paraffin inhibition and that may also be capable of exhibiting a broad spectrum of benefits, particularly when added to a petroleum source.

### SUMMARY OF THE INVENTION

In accordance with one embodiment of the present invention, an acrylate copolymer is disclosed that has the following repeating units (A) and (B):

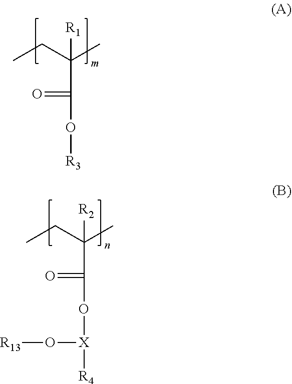

wherein,

R₁ and R₂ are each independently H or a C₁-C₂ alkyl;

R₃ is a C₈-C₅₀ alkyl, a C₈-C₅₀ alkenyl, or a C₈-C₅₀ alkynyl;

X is a divalent radical;

R₄ is a C₄-C₅₀ alkyl, a C₄-C₅₀ alkenyl, a C₄-C₅₀ alkynyl, a C₄-C₁₀ aryl, or —R₅-R₆;
wherein,
   R₅ is —C(O)O—, —OC(O)—, —C(O)—, —C(O)N(R₁₀)—, —N(R₁₁)C(O)—, —N(R₁₂)—, or —O—;
   R₆ is an alkyl, an alkenyl, an alkynyl, or an aryl; and
   R₁₀, R₁₁, and R₁₂ are each independently H, an alkyl, an alkenyl, or an alkynyl;

R₁₃ is H, an alkyl, an alkenyl, an alkynyl, or an aryl;

m is an integer from 1 to 200; and

n is an integer from 1 to 200.

In accordance with another embodiment of the present invention, a paraffin inhibitor composition is disclosed comprising the acrylate copolymer as described above.

In accordance with another embodiment of the present invention, a petroleum composition is disclosed comprising the paraffin inhibitor composition as described above and a petroleum source.

In accordance with another embodiment of the present invention, a method for modifying a petroleum source is disclosed. The method comprises adding the paraffin inhibitor composition as described above to a petroleum source.

In accordance with another embodiment of the present invention, a method of synthesizing an acrylate copolymer as described above is disclosed. The method comprises polymerizing a monomer for repeating unit (A) with a monomer for repeating unit (B)

Other features and aspects of the present invention are set forth in greater detail below.

### Definitions

It is to be understood that the terminology used herein is for the purpose of describing particular embodiments only and is not intended to limit the scope of the present invention.

“Alkyl” refers to straight chain, branched chain, or cyclic monovalent saturated aliphatic hydrocarbyl groups and “C_{q}-Cᵣ alkyl” refers to alkyl groups having from q to r carbon atoms. This term includes, by way of example, straight chain, branched chain, or cyclic hydrocarbyl groups, such as methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, icosanyl, henicosanyl, docosanyl, tricosanyl, tetracosanyl, pentacosanyl, hexacosanyl, heptacosanyl, octacosanyl, and the like. Alkyl includes a substituted alkyl or an unsubstituted alkyl. For example, the alkyl may be substituted (e.g., having from 1 to 5 and, in some embodiments, 1 to 3 or 1 to 2 substituents). Alternatively, the alkyl may be unsubstituted.

“Alkylene” refers to a straight chain or branched chain divalent hydrocarbyl. For example, “C_{q}-Cᵣ alkylene” refers to an alkylene group having from q to r carbon atoms. This term includes, by way of example, straight chain or branched chain hydrocarbyl groups, such as methylene, ethylene, propylene (e.g., n-propylene), butylene (e.g., n-butylene), and the like.

“Alkenyl” refers to a straight chain or branched chain monovalent aliphatic hydrocarbyl group having at least 1 site of vinyl unsaturation (>C═C<). For example, “C_{q}-Cᵣ alkenyl” refers to alkenyl groups having from q to r carbon atoms. This term includes, by way of example, straight chain or branched chain hydrocarbyl groups, such as ethenyl, propenyl, 1,3-butadienyl, and the like. Alkenyl includes a substituted alkenyl or an unsubstituted alkenyl. For example, the alkenyl may be substituted (e.g., having from 1 to 5 and, in some embodiments, 1 to 3 or 1 to 2 substituents). Alternatively, the alkenyl may be unsubstituted.

“Alkynyl” refers to a straight chain or branched chain monovalent aliphatic hydrocarbyl group having at least one carbon triple bond. The term “alkynyl” is also meant to include those hydrocarbyl groups having one triple bond and one double bond. For example, “C_{q}-Cᵣ alkynyl” refers to alkynyl groups having from q to r carbon atoms. This term includes, by way of example, straight chain or branched chain hydrocarbyl groups, such as ethynyl, propynyl, and the like. Alkynyl includes a substituted alkynyl or an unsubstituted alkynyl. For example, the alkynyl may be substituted (e.g., having from 1 to 5 and, in some embodiments, 1 to 3 or 1 to 2 substituents). Alternatively, the alkynyl may be unsubstituted.

“Aryl” refers to an aromatic hydrocarbyl group. For example, “C_{q}-Cᵣ aryl” refers to aryl groups having from q to r carbon atoms. This term includes, by way of example, linear and branched hydrocarbyl groups, such as phenyl, naphthyl, indenyl, azulenyl, fluorenyl, anthracenyl, phenanthrenyl, tetrahydronaphthyl, indanyl, phenanthridinyl and the like. Aryl includes a substituted aryl or an unsubstituted aryl. For example, the aryl may be substituted (e.g., having from 1 to 5 and, in some embodiments, 1 to 3 or 1 to 2 substituents). Alternatively, the aryl may be unsubstituted.

It is understood that the above definitions are not intended to include impermissible substitution patterns (e.g., methyl substituted with 5 fluoro groups). Such impermissible substitution patterns are well known to a person skilled in the art.

### DETAILED DESCRIPTION

It is to be understood by one of ordinary skill in the art that the present discussion is a description of exemplary embodiments only, and is not intended as limiting the broader aspects of the present invention.

Generally speaking, the present invention is directed to an acrylate copolymer that can exhibit a broad spectrum of benefits, particularly when used to modify a petroleum source. Namely, by selectively controlling various aspects of the acrylate copolymer, such as the type and/or relative concentrations of the monomers, the present inventors have discovered that the resulting acrylate copolymer can be tailored to provide a wide variety of beneficial properties to a petroleum composition. For example, the acrylate copolymer can function at least as a paraffin inhibitor. However, the acrylate copolymer may be capable of serving two or more beneficial functions thereby being recognized as “multi-functional.” This may allow for a reduction in costs and a simplification of operations as it can allow for a single material to accomplish multiple functions rather than requiring the use of two or more separate materials.

The acrylate copolymer generally has the following repeating units (A) and (B):

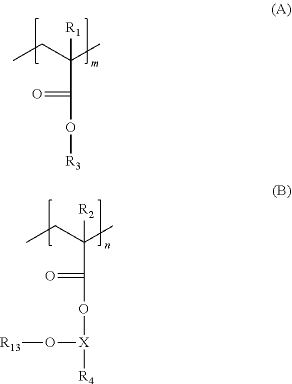

wherein,

R₁ and R₂ are each independently H or a C₁-C₂ alkyl;

R₃ is a C₈-C₅₀ alkyl, a C₈-C₅₀ alkenyl, or a C₈-C₅₀ alkynyl;

X is a divalent radical;

R₄ is a C₄-C₅₀ alkyl, a C₄-C₅₀ alkenyl, a C₄-C₅₀ alkynyl, a C₄-C₁₀ aryl, or —R₅-R₆;
wherein,
   R₅ is —C(O)O—, —OC(O)—, —C(O)—, —C(O)N(R₁₀)—, —N(R₁₁)C(O)—, —N(R₁₂)—, or —O—;
   R₆ is an alkyl, an alkenyl, an alkynyl, or an aryl; and
   R₁₀, R₁₁, and R₁₂ are each independently H, an alkyl, an alkenyl, or an alkynyl;

R₁₃ is H, an alkyl, an alkenyl, an alkynyl, or an aryl;

m is an integer from 1 to 200; and

n is an integer from 1 to 200.

As indicated above, R₁ is H or a C₁-C₂ alkyl. In one embodiment, R₁ is H. In another embodiment, R₁ is a C₁-C₂ alkyl. For instance, R₁ may be a C₁ alkyl (i.e., methyl). Alternatively, R₁ may be a C₂ alkyl (i.e., ethyl).

As indicated above, R₂ is H or a C₁-C₂ alkyl. In one embodiment, R₂ is H. In another embodiment, R₂ is a C₁-C₂ alkyl. For instance, R₂ may be a C₁ alkyl (i.e., methyl). Alternatively, R₂ may be a C₂ alkyl (i.e., ethyl).

In one embodiment, at least one of R₁ and R₂ may be H. In another embodiment, at least one of R₁ and R₂ may be a C₁-C₂ alkyl. For instance, at least one of R₁ and R₂ may be a C₁ alkyl.

In one embodiment, R₁ and R₂ may be the same. For example, in one embodiment, R₁ and R₂ may both be H. In another embodiment, R₁ and R₂ may both be a C₁ alkyl (i.e., methyl). Alternatively, R₁ and R₂ may both be a C₂ alkyl (i.e., ethyl). However, it should also be understood that R₁ and R₂ may also be different. For example, one of R₁ and R₂ may be H while the other of R₁ and R₂ may be a C₁-C₂ alkyl. Alternatively, R₁ and R₂ may each be a different C₁-C₂ alkyl.

As indicated above, R₃ is a C₈-C₅₀ alkyl, a C₈-C₅₀ alkenyl, or a C₈-C₅₀ alkynyl. In one embodiment, R₃ is a C₈-C₅₀ alkyl. In another embodiment, R₃ is a C₈-C₅₀ alkenyl. In a further embodiment, R₃ is a C₈-C₅₀ alkynyl.

In one embodiment, R₃ includes a C₈-C₅₀ alkyl. In this regard, the R₃ alkyl may be a C₈-C₅₀ alkyl, such as a C₈-C₄₄ alkyl, such as a C₁₀-C₄₂ alkyl, such as a C₁₀-C₄₀ alkyl, such as a C₁₂-C₃₆ alkyl, such as a C₁₂-C₃₂ alkyl, such as a C₁₄-C₃₀ alkyl, such as a C₁₆-C₂₆ alkyl, such as a C₁₆-C₂₄ alkyl, such as a C₁₆₋₂₂ alkyl. For instance, the R₃ alkyl may have 8 or more, such as 10 or more, such as 12 or more, such as 14 or more, such as 16 or more, such as 18 or more, such as 20 or more, such as 24 or more carbon atoms. The R₃ alkyl may have 50 or less, such as 44 or less, such as 40 or less, such as 36 or less, such as 32 or less, such as 30 or less, such as 26 or less, such as 24 or less, such as 20 or less, such as 18 or less carbon atoms. In addition, the R₃ alkyl may be a straight chain, a branched chain, or cyclic. In one embodiment, the R₃ alkyl is a straight chain. In another embodiment, the R₃ alkyl is a branched chain. In a further embodiment, the R₃ alkyl is cyclic.

In one embodiment, the R₃ alkyl may be a branched chain alkyl. In this regard, the R₃ alkyl may be provided by reacting a Guerbet alcohol with the monomer precursor (i.e., the acrylic). As generally known in the art, Guerbet alcohols are saturated primary alcohols with branching of the carbon chain. In this regard, such alcohols may be described as 2-alkyl-1-alkanols. Without being limited, these alcohols may yield 2-butyl hexyl, 2-butyl octyl, 2-butyl decyl, 2-butyl dodecyl, 2-butyl tetradecyl, 2-butyl hexadecyl, 2-butyl octadecyl, 2-hexyl octyl, 2-hexyl decyl, 2-hexyl dodecyl, 2-hexyl tetradecyl, 2-hexyl hexadecyl, 2-hexyl octadecyl, 2-octyl hexyl, 2-octyl decyl, 2-octyl dodecyl, 2-octyl tetradecyl, 2-octyl hexadecyl, 2-octyl octadecyl, 2-decyl hexyl, 2-decyl octyl, 2-decyl dodecyl, 2-decyl tetradecyl, 2-decyl hexadecyl, 2-decyl octadecyl, 2-dodecyl hexyl, 2-dodecyl octyl, 2-dodecyl decyl, 2-dodecyl tetradecyl, 2-dodecyl hexadecyl, 2-dodecyl octadecyl, 2-tetradecyl hexyl, 2-tetradecyl octyl, 2-tetradecyl decyl, 2-tetradecyl dodecyl, 2-tetradecyl hexadecyl, and 2-tetradecyl octadecyl.

In another embodiment, R₃ includes a C₈-C₅₀ alkenyl. In this regard, the R₃ alkenyl may be a C₈-C₅₀ alkenyl, such as a C₈-C₄₄ alkenyl, such as a C₁₀-C₄₂ alkenyl, such as a C₁₀-C₄₀ alkenyl, such as a C₁₂-C₃₆ alkenyl, such as a C₁₂-C₃₂ alkenyl, such as a C₁₄-C₃₀ alkenyl, such as a C₁₆-C₂₆ alkenyl, such as a C₁₆-C₂₄ alkenyl, such as a C₁₆-C₂₂ alkenyl. For instance, the R₃ alkenyl may have 8 or more, such as 10 or more, such as 12 or more, such as 14 or more, such as 16 or more, such as 18 or more, such as 20 or more, such as 24 or more carbon atoms. The R₃ alkenyl may have 50 or less, such as 44 or less, such as 40 or less, such as 36 or less, such as 32 or less, such as 30 or less, such as 26 or less, such as 24 or less, such as 20 or less, such as 18 or less carbon atoms. In addition, the R₃ alkenyl may be a straight chain or a branched chain. In one embodiment, the R₃ alkenyl is a straight chain. In another embodiment, the R₃ alkenyl is a branched chain.

In a further embodiment, R₃ includes a C₈-C₅₀ alkynyl. In this regard, the R₃ alkynyl may be a C₈-C₅₀ alkynyl, such as a C₈-C₄₄ alkynyl, such as a C₁₀-C₄₂ alkynyl, such as a C₁₀-C₄₀ alkynyl, such as a C₁₂-C₃₆ alkynyl, such as a C₁₂-C₃₂ alkynyl, such as a C₁₄-C₃₀ alkynyl, such as a C₁₆-C₂₆ alkynyl, such as a C₁₆-C₂₄ alkynyl, such as a C₁₆-C₂₂ alkynyl. For instance, the R₃ alkynyl may have 8 or more, such as 10 or more, such as 12 or more, such as 14 or more, such as 16 or more, such as 18 or more, such as 20 or more, such as 24 or more carbon atoms. The R₃ alkynyl may have 50 or less, such as 44 or less, such as 40 or less, such as 36 or less, such as 32 or less, such as 30 or less, such as 26 or less, such as 24 or less, such as 20 or less, such as 18 or less carbon atoms. In addition, the R₃ alkynyl may be a straight chain or a branched chain. In one embodiment, the R₃ alkynyl is a straight chain. In another embodiment, the R₃ alkynyl is a branched chain.

As indicated above, X is a divalent radical. For instance, X may be an alkylene (i.e., an alkylene bridge) bonded to the adjacent oxygen and R₄. For instance, the alkylene may be a C₁-C₈ alkylene, such as a C₁-C₅ alkylene, such as a C₁-C₃ alkylene, such as a C₁-C₂ alkylene or a C₂-C₃ alkylene. In this regard, the alkylene may be a methylene, an ethylene, a propylene, a butylene, etc. For instance, the alkylene may be an ethylene or a propylene. In one embodiment, the alkylene may be a methylene. In another embodiment, the alkylene may be an ethylene. In a further embodiment, the alkylene may be a propylene.

As indicated above, R₄ is a C₄-C₅₀ alkyl, a C₄-C₅₀ alkenyl, a C₄-C₅₀ alkynyl, a C₄-C₁₀ aryl, or —R₅-R₆ wherein R₅ and R₆ are as defined above. In one embodiment, R₄ is a C₄-C₅₀ alkyl. In another embodiment, R₄ is a C₄-C₅₀ alkenyl. In a further embodiment, R₄ is a C₄-C₅₀ alkynyl. In an even further embodiment, R₄ is —R₅-R₆ wherein R₅ and R₆ are as defined above.

In one embodiment, R₄ includes a C₄-C₅₀ alkyl. In this regard, the R₄ alkyl may be a C₄-C₅₀ alkyl, such as a C₄-C₄₀ alkyl, such as a C₅-C₃₀ alkyl, such as a C₆-C₂₀ alkyl, such as a C₆-C₁ alkyl, such as a C₆-C₁₄ alkyl, such as a C₈-C₁₂ alkyl. For instance, the R₄ alkyl may have 4 or more, such as 5 or more, such as 6 or more, such as 7 or more, such as 8 or more, such as 10 or more, such as 12 or more, such as 14 or more, such as 16 or more, such as 18 or more, such as 20 or more carbon atoms. The R₄ alkyl may have 50 or less, such as 44 or less, such as 40 or less, such as 32 or less, such as 30 or less, such as 24 or less, such as 20 or less, such as 18 or less, such as 16 or less, such as 14 or less, such as 12 or less, such as 10 or less carbon atoms. In addition, the R₄ alkyl may be a straight chain, a branched chain, or cyclic. In one embodiment, the R₄ alkyl is a straight chain. In another embodiment, the R₄ alkyl is a branched chain. In a further embodiment, the R₄ alkyl is cyclic.

In another embodiment, R₄ includes a C₄-C₅₀ alkenyl. In this regard, the R₄ alkenyl may be a C₄-C₅₀ alkenyl, such as a C₄-C₄₀ alkenyl, such as a C₅-C₃₀ alkenyl, such as a C₆-C₂₀ alkenyl, such as a C₆-C₁ alkenyl, such as a C₆-C₁₄ alkenyl, such as a C₈-C₁₂ alkenyl. For instance, the R₄ alkenyl may have 4 or more, such as 5 or more, such as 6 or more, such as 7 or more, such as 8 or more, such as 10 or more, such as 12 or more, such as 14 or more, such as 16 or more, such as 18 or more, such as 20 or more carbon atoms. The R₄ alkenyl may have 50 or less, such as 44 or less, such as 40 or less, such as 32 or less, such as 30 or less, such as 24 or less, such as 20 or less, such as 18 or less, such as 16 or less, such as 14 or less, such as 12 or less, such as 10 or less carbon atoms. In addition, the R₄ alkenyl may be a straight chain or a branched chain. In one embodiment, the R₄ alkenyl is a straight chain. In another embodiment, the R₄ alkenyl is a branched chain.

In a further embodiment, R₄ includes a C₄-C₅₀ alkynyl. In this regard, the R₄ alkynyl may be a C₄-C₅₀ alkynyl, such as a C₄-C₄₀ alkynyl, such as a C₅-C₃₀ alkynyl, such as a C₆-C₂₀ alkynyl, such as a C₆-C₁ alkynyl, such as a C₆-C₁₄ alkynyl, such as a C₈-C₁₂ alkynyl. For instance, the R₄ alkynyl may have 4 or more, such as 5 or more, such as 6 or more, such as 7 or more, such as 8 or more, such as 10 or more, such as 12 or more, such as 14 or more, such as 16 or more, such as 18 or more, such as 20 or more carbon atoms. The R₄ alkynyl may have 50 or less, such as 44 or less, such as 40 or less, such as 32 or less, such as 30 or less, such as 24 or less, such as 20 or less, such as 18 or less, such as 16 or less, such as 14 or less, such as 12 or less, such as 10 or less carbon atoms. In addition, the R₄ alkynyl may be a straight chain or a branched chain. In one embodiment, the R₄ alkynyl is a straight chain. In another embodiment, the R₄ alkynyl is a branched chain.

In another further embodiment, R₄ includes a C₄-C₁₀ aryl. In this regard, the R₄ aryl may be a C₄-C₁₀ aryl, such as a C₄-C₈ aryl, such as a C₆-C₈ aryl. For instance, the R₄ aryl may have 4 or more, such as 5 or more, such as 6 or more carbon atoms. The R₄ aryl may have 10 or less, such as 8 or less, such as 7 or less, such as 6 or less, such as 5 or less carbon atoms. In addition, in one embodiment, the R₄ aryl may be polycyclic. The polycyclic aryl may include fused, bridged, and spiro ring systems.

In an even further embodiment, R₄ is —R₅-R₆ wherein R₅ is —C(O)O—, —OC(O)—, —C(O)—, —C(O)N(R₁₀)—, —N(R₁₁)C(O)—, —N(R₁₂)—, or —O—; R₆ is an alkyl, an alkenyl, or an alkynyl; and R₁₀, R₁₁, and R₁₂ are each independently H, an alkyl, an alkenyl, or an alkynyl.

As indicated above, R₅ is —C(O)O—, —OC(O)—, —C(O)—, —C(O)N(R₁₀)—, —N(R₁₁)C(O)—, —N(R₁₂)—, or —O—. For instance, in one embodiment, R₅ may be —C(O)O—, —OC(O)—, —C(O)N(R₁₀)—, or —N(R₁₁)C(O)—. In another embodiment, R₅ may be —C(O)O— or —OC(O)—. In a further embodiment, R₅ may be —OC(O)— or —N(R₁₁)C(O)—. In this regard, in one embodiment, R₅ is —C(O)O—. In another embodiment, R₅ is —OC(O)—. In a further embodiment, R₅ is —C(O)—. In an even further embodiment, R₅ is —C(O)N(R₁₀)—. In another embodiment, R₅ is —N(R₆)C(O)—. In a further embodiment, R₅ is —N(R₁₂)—. In another embodiment, R₅ is —O—.

As indicated above, in one embodiment, R₅ may be —C(O)N(R₁₀)—, —N(R₁₁)C(O)—, or —N(R₁₂)—. In this regard, as also indicated above, R₁₀, R₁₁, and R₁₂ may each independently be H, an alkyl, an alkenyl, or an alkynyl. Thus, in one embodiment, R₁₀ may be H, an alkyl, an alkenyl, or an alkynyl. In this regard, in one embodiment, R₁₀ may be H. In another embodiment, R₁₀ may be an alkyl. In a further embodiment, R₁₀ may be an alkenyl. In an even further embodiment, R₁₀ may be an alkynyl. Similarly, in one embodiment, R₁₁ may be H, an alkyl, an alkenyl, or an alkynyl. In this regard, in one embodiment, R₁₁ may be H. In another embodiment, R₁₁ may be an alkyl. In a further embodiment, R₁₁ may be an alkenyl. In an even further embodiment, R₁₁ may be an alkynyl. Also, similarly, R₁₂ may be H, an alkyl, an alkenyl, or an alkynyl. In this regard, in one embodiment, R₁₂ may be H. In another embodiment, R₁₂ may be an alkyl. In a further embodiment, R₁₂ may be an alkenyl. In an even further embodiment, R₁₂ may be an alkynyl.

With respect to the R₁₀, R₁₁, and R₁₂ groups, it should be understood that they may not necessarily be limited. For instance, the alkyl may have 1 or more, such as 2 or more, such as 3 or more, such as 4 or more, such as 5 or more, such as 6 or more, such as 7 or more, such as 10 or more, such as 12 or more, such as 15 or more carbon atoms, such as 18 or more, such as 20 or more carbon atoms. The alkyl may have 50 or less, such as 44 or less, such as 40 or less, such as 32 or less, such as 30 or less, such as 24 or less, such as 20 or less, such as 18 or less, such as 15 or less, such as 13 or less, such as 10 or less, such as 8 or less, such as 6 or less, such as 5 or less, such as 4 or less carbon atoms. In addition, the alkyl may be a straight chain, a branched chain, or cyclic. In one embodiment, the alkyl is a straight chain. In another embodiment, the alkyl is a branched chain. In a further embodiment, the alkyl is cyclic.

Similarly, the alkenyl or alkynyl may have 2 or more, such as 3 or more, such as 4 or more, such as 5 or more, such as 6 or more, such as 7 or more, such as 10 or more, such as 12 or more, such as 15 or more carbon atoms, such as 18 or more, such as 20 or more carbon atoms. The alkenyl or alkynyl may have 50 or less, such as 44 or less, such as 40 or less, such as 32 or less, such as 30 or less, such as 24 or less, such as 20 or less, such as 18 or less, such as 15 or less, such as 13 or less, such as 10 or less, such as 8 or less, such as 6 or less, such as 5 or less, such as 4 or less carbon atoms. In addition, the alkenyl or alkynyl may be a straight chain or a branched chain, or cyclic. In one embodiment, it may be a straight chain. In another embodiment, it may be a branched chain.

As indicated above, R₆ is an alkyl, an alkenyl, an alkynyl, or an aryl. In this regard, in one embodiment, R₆ may be an alkyl. In another embodiment, R₆ may be an alkenyl. In a further embodiment, R₆ may be an alkynyl. In an even further embodiment, R₆ may be an aryl.

In one embodiment, R₆ includes an alkyl. For example, the R₆ alkyl may be a C₁-C₅₀ alkyl, such as a C₂-C₅₀ alkyl, such as a C₄-C₅₀ alkyl, such as a C₄-C₄₀ alkyl, such as a C₅-C₃₀ alkyl, such as a C₆-C₂₀ alkyl, such as a C₆-C₁₆ alkyl, such as a C₆-C₁₄ alkyl, such as a C₈-C₁₂ alkyl. For instance, the R₆ alkyl may have 1 or more, such as 2 or more, such as 4 or more, such as 5 or more, such as 6 or more, such as 7 or more, such as 8 or more, such as 10 or more, such as 12 or more, such as 14 or more, such as 16 or more, such as 18 or more, such as 20 or more carbon atoms. The R₆ alkyl may have 50 or less, such as 44 or less, such as 40 or less, such as 32 or less, such as 30 or less, such as 24 or less, such as 20 or less, such as 18 or less, such as 16 or less, such as 14 or less, such as 12 or less, such as 10 or less carbon atoms. In addition, the R₆ alkyl may be a straight chain, a branched chain, or cyclic. In one embodiment, the R₆ alkyl is a straight chain. In another embodiment, the R₆ alkyl is a branched chain. In a further embodiment, the R₆ alkyl is cyclic.

In another embodiment, R₆ includes an alkenyl. For example, the R₆ alkenyl may be a C₂-C₅₀ alkenyl, such as a C₄-C₄₀ alkenyl, such as a C₅-C₃₀ alkenyl, such as a C₆-C₂₀ alkenyl, such as a C₆-C₁₆ alkenyl, such as a C₆-C₁₄ alkenyl, such as a C₈-C₁₂ alkenyl. For instance, the R₆ alkenyl may have 2 or more, such as 4 or more, such as 5 or more, such as 6 or more, such as 7 or more, such as 8 or more, such as 10 or more, such as 12 or more, such as 14 or more, such as 16 or more, such as 18 or more, such as 20 or more carbon atoms. The R₆ alkenyl may have 50 or less, such as 44 or less, such as 40 or less, such as 32 or less, such as 30 or less, such as 24 or less, such as 20 or less, such as 18 or less, such as 16 or less, such as 14 or less, such as 12 or less, such as 10 or less carbon atoms. In addition, the R₆ alkenyl may be a straight chain or a branched chain. In one embodiment, the R₆ alkenyl is a straight chain. In another embodiment, the R₆ alkenyl is a branched chain.

In a further embodiment, R₆ includes an alkynyl. For example, the R₆ alkynyl may be a C₂-C₅₀ alkynyl, such as a C₄-C₅₀ alkynyl, such as a C₄-C₄₀ alkynyl, such as a C₅-C₃₀ alkynyl, such as a C₆-C₂₀ alkynyl, such as a C₆-C₁₆ alkynyl, such as a C₆-C₁₄ alkynyl, such as a C₈-C₁₂ alkynyl. For instance, the R₆ alkynyl may have 2 or more, such as 4 or more, such as 5 or more, such as 6 or more, such as 7 or more, such as 8 or more, such as 10 or more, such as 12 or more, such as 14 or more, such as 16 or more, such as 18 or more, such as 20 or more carbon atoms. The R₆ alkynyl may have 50 or less, such as 44 or less, such as 40 or less, such as 32 or less, such as 30 or less, such as 24 or less, such as 20 or less, such as 18 or less, such as 16 or less, such as 14 or less, such as 12 or less, such as 10 or less carbon atoms. In addition, the R₆ alkynyl may be a straight chain or a branched chain. In one embodiment, the R₆ alkynyl is a straight chain. In another embodiment, the R₆ alkynyl is a branched chain.

In an even further embodiment, R₆ includes an aryl. For example, the R₆ aryl may be a C₄-C₁₀ aryl, such as a C₄-C₈ aryl, such as a C₆-C₈ aryl. For instance, the R₄ aryl may have 4 or more, such as 5 or more, such as 6 or more carbon atoms. The R₄ aryl may have 10 or less, such as 8 or less, such as 7 or less, such as 6 or less, such as 5 or less carbon atoms. In addition, in one embodiment, the R₄ aryl may be polycyclic. The polycyclic aryl may include fused, bridged, and spiro ring systems.

As indicated above in the structure of repeating unit (B), —O—R₁₃ extends from the divalent radical X. If the divalent radical includes more than one carbon atom, the carbon to which the O is bonded is not necessarily limited. In one embodiment, the O may be bonded to a terminal carbon of the divalent radical. In another embodiment, the O may be bonded to an interior carbon of the divalent radical. For example, if X is propylene (e.g., n-propylene), the O may be bonded to the second carbon of the propylene bridge.

Furthermore, as also indicated above, R₁₃ may be H, an alkyl, an alkenyl, an alkynyl, or an aryl. In this regard, in one embodiment, R₁₃ may be H. In another embodiment, R₁₃ may be an alkyl. In a further embodiment, R₁₃ may be an alkenyl. In an even further embodiment, R₁₃ may be an alkynyl. In another further embodiment, R₁₃ may be an aryl.

With respect to the R₁₃ groups, it should be understood that they may not necessarily be limited. For instance, the R₁₃ alkyl may have 1 or more, such as 2 or more, such as 3 or more, such as 4 or more, such as 5 or more, such as 6 or more, such as 7 or more, such as 10 or more, such as 12 or more, such as 15 or more carbon atoms, such as 18 or more, such as 20 or more carbon atoms. The R₁₃ alkyl may have 50 or less, such as 44 or less, such as 40 or less, such as 32 or less, such as 30 or less, such as 24 or less, such as 20 or less, such as 18 or less, such as 15 or less, such as 13 or less, such as 10 or less, such as 8 or less, such as 6 or less, such as 5 or less, such as 4 or less carbon atoms. In addition, the R₁₃ alkyl may be a straight chain, a branched chain, or cyclic. In one embodiment, the R₁₃ alkyl is a straight chain. In another embodiment, the R₁₃ alkyl is a branched chain. In a further embodiment, the R₁₃ alkyl is cyclic.

Similarly, the R₁₃ alkenyl or alkynyl may have 2 or more, such as 3 or more, such as 4 or more, such as 5 or more, such as 6 or more, such as 7 or more, such as 10 or more, such as 12 or more, such as 15 or more carbon atoms, such as 18 or more, such as 20 or more carbon atoms. The R₁₃ alkenyl or alkynyl may have 50 or less, such as 44 or less, such as 40 or less, such as 32 or less, such as 30 or less, such as 24 or less, such as 20 or less, such as 18 or less, such as 15 or less, such as 13 or less, such as 10 or less, such as 8 or less, such as 6 or less, such as 5 or less, such as 4 or less carbon atoms. In addition, the R₁₃ alkenyl or alkynyl may be a straight chain or a branched chain, or cyclic. In one embodiment, it may be a straight chain. In another embodiment, it may be a branched chain.

In an even further embodiment, the R₁₃ aryl may have 4 or more, such as 5 or more, such as 6 or more carbon atoms. The R₁₃ aryl may have 10 or less, such as 8 or less, such as 7 or less, such as 6 or less, such as 5 or less carbon atoms. In addition, in one embodiment, the R₁₃ aryl may be polycyclic. The polycyclic aryl may include fused, bridged, and spiro ring systems.

In one particular embodiment, repeating unit (B) may have the following structure:

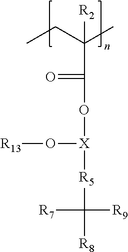

wherein,

R₇, R₈, and R₉ are each independently H, an alkyl, an alkenyl, an alkynyl, or an aryl wherein at least one of R₇, R₈, and R₉ is not H.

As indicated above, R₇, R₈, and R₉ are each independently H, an alkyl, an alkenyl, an alkynyl, or an aryl. However, at least one of R₇, R₈, and R₉ is not H. In a further embodiment, at least two of R₇, R₈, and R₉ are not H. In addition, in one embodiment, at least one of R₇, R₈, and R₉ is an alkyl. In another embodiment, at least two of R₇, R₈, and R₉ are an alkyl. In another further embodiment, at least two of R₇, R₈, and R₉ are an alkyl wherein they are each a different alkyl. Alternatively, in one embodiment, they may be the same alkyl.

As indicated above, R₇ is H, an alkyl, an alkenyl, an alkynyl, or an aryl. In one embodiment, R₇ is H. In another embodiment, R₇ is an alkyl. In a further embodiment, R₇ is an alkenyl. In an even further embodiment, R₇ is an alkynyl. In another further embodiment, R₇ is an aryl.

As indicated above, R₈ is H, an alkyl, an alkenyl, alkynyl, or an aryl. In one embodiment, R₈ is H. In another embodiment, R₈ is an alkyl. In a further embodiment, R₈ is an alkenyl. In an even further embodiment, R₈ is an alkynyl. In another further embodiment, R₈ is an aryl.

As indicated above, R₉ is H, an alkyl, an alkenyl, alkynyl, or an aryl. In one embodiment, R₉ is H. In another embodiment, R₉ is an alkyl. In a further embodiment, R₉ is an alkenyl. In an even further embodiment, R₉ is an alkynyl. In another further embodiment, R₉ is an aryl.

With respect to R₇, R₈, and R₉, the alkyl may be a C₁-C₂₀ alkyl, the alkenyl may be a C₂-C₂₀ alkenyl, the alkynyl may be a C₂-C₂₀ alkynyl, and the aryl may be a C₄-C₁₀ aryl.

Accordingly, the alkyl may be a C₁-C₂₀ alkyl. In this regard, the alkyl may have 1 or more, such as 2 or more, such as 3 or more, such as 4 or more, such as 5 or more, such as 6 or more, such as 7 or more, such as 10 or more, such as 12 or more, such as 15 or more carbon atoms. The alkyl may have 20 or less, such as 18 or less, such as 15 or less, such as 13 or less, such as 10 or less, such as 8 or less, such as 6 or less, such as 5 or less, such as 4 or less carbon atoms. In addition, the alkyl may be a straight chain, a branched chain, or cyclic. In one embodiment, the alkyl is a straight chain. In another embodiment, the alkyl is a branched chain. In a further embodiment, the alkyl is cyclic.

Also, the alkenyl may be a C₂-C₂₀ alkenyl. In this regard, the alkenyl may have 2 or more, such as 3 or more, such as 4 or more, such as 5 or more, such as 6 or more, such as 7 or more, such as 10 or more, such as 12 or more, such as 15 or more carbon atoms. The alkenyl may have 20 or less, such as 18 or less, such as 15 or less, such as 13 or less, such as 10 or less, such as 8 or less, such as 6 or less, such as 5 or less, such as 4 or less carbon atoms. In addition, the alkenyl may be a straight chain or a branched chain. In one embodiment, the alkenyl is a straight chain. In another embodiment, the alkenyl is a branched chain.

Further, the alkynyl may be a C₂-C₂₀ alkynyl. In this regard, the alkynyl may have 2 or more, such as 3 or more, such as 4 or more, such as 5 or more, such as 6 or more, such as 7 or more, such as 10 or more, such as 12 or more, such as 15 or more carbon atoms. The alkynyl may have 20 or less, such as 18 or less, such as 15 or less, such as 13 or less, such as 10 or less, such as 8 or less, such as 6 or less, such as 5 or less, such as 4 or less carbon atoms. In addition, the alkynyl may be a straight chain or a branched chain. In one embodiment, the alkynyl is a straight chain. In another embodiment, the alkynyl is a branched chain.

In addition, the aryl may be a C₄-C₁₀ aryl. In this regard, the aryl may have 4 or more, such as 5 or more, such as 6 or more carbon atoms. The aryl may have 10 or less, such as 8 or less, such as 7 or less, such as 6 or less, such as 5 or less carbon atoms. In addition, in one embodiment, the aryl may be polycyclic. The polycyclic aryl may include fused, bridged, and spiro ring systems.

With respect to R₇, R₈, and R₉, at least one may be an alkyl having from 1 to 4 carbon atoms. Also, with respect to R₇, R₈, and R₉, at least one may be an alkyl having from 5 to 10 carbon atoms. In one embodiment, at least one of R₇, R₈, and R₉ is an alkyl having from 1 to 4 carbon atoms and at least one of R₇, R₈, and R₉ is an alkyl having from 5 to 10 carbon atoms. For example, at least one of R₇, R₈, and R₉ is methyl. In one embodiment, at least two of R₇, R₈, and R₉ are methyl. Alternatively, at least one of R₇, R₈, and R₉ is ethyl. In one embodiment, at least two of R₇, R₈, and R₉ are ethyl. In a further embodiment, at least one of R₇, R₈, and R₉ is methyl and at least one of R₇, R₈, and R₉ is ethyl.

As indicated above, “m” is an integer from 1 to 200. In this regard, “m” may be 1 or more, such as 2 or more, such as 3 or more, such as 5 or more, such as 10 or more, such as 20 or more, such as 25 or more, such as 30 or more, such as 40 or more, such as 50 or more, such as 75 or more, such as 100 or more, such as 125 or more, such as 150 or more. In addition, “m” may be 200 or less, such as 175 or less, such as 150 or less, such as 125 or less, such as 100 or less, such as 90 or less, such as 80 or less, such as 75 or less, such as 50 or less, such as 40 or less, such as 30 or less, such as 25 or less.

As also indicated above, “n” is an integer from 1 to 200. In this regard, “n” may be 1 or more, such as 2 or more, such as 3 or more, such as 5 or more, such as 10 or more, such as 20 or more, such as 25 or more, such as 30 or more, such as 40 or more, such as 50 or more, such as 75 or more, such as 100 or more, such as 125 or more, such as 150 or more. In addition, “n” may be 200 or less, such as 175 or less, such as 150 or less, such as 125 or less, such as 100 or less, such as 90 or less, such as 80 or less, such as 75 or less, such as 50 or less, such as 40 or less, such as 30 or less, such as 25 or less.

To help tailor the desired properties of the acrylate copolymer for the intended functionality, the balance between the content of the repeating units (A) and (B), as well as their respective molecular weights, may be selectively controlled. For instance, the repeating unit (A) of the copolymer may constitute at least 0.1%, such as at least 0.5%, such as at least 1%, such as at least 2%, such as at least 5%, such as at least 10%, such as at least 15%, such as at least 25%, such as at least 40%, such as at least 50% to 98% or less, such as 95% or less, such as 90% or less, such as 80% or less, such as 75% or less, such as 60% or less, such as 50% or less, such as 40% or less, such as 30% or less, such as 20% or less, such as 15% or less, such as 10% or less, such as 8% or less, such as 6% or less of the repeating units of the copolymer. Likewise, the repeating unit (B) of the copolymer may constitute at least 1%, such as at least 2%, such as at least 5%, such as at least 10%, such as at least 15%, such as at least 25%, such as at least 30%, such as at least 40%, such as at least 50%, such as at least 60%, such as at least 70%, such as at least 75% to 98% or less, such as 96% or less, such as 94% or less, such as 90% or less, such as 85% or less, such as 80% or less, such as 75% or less, such as 65% or less, such as 60% or less, such as 50% or less, such as 40% or less of the repeating units of the copolymer. Similarly, repeating units (A) and (B) of the copolymer together may constitute at least 40%, such as at least 50%, such as at least 60%, such as at least 70%, such as at least 75% to 100% or less, such as 98% or less, such as 96% or less, such as 94% or less, such as 90% or less, such as 85% or less, such as 80% or less, such as 75% or less, such as 65% or less, such as 60% or less, such as 50% or less, such as 40% or less of the repeating units of the copolymer. In addition, while the aforementioned percentages are presented with respect to the number of repeating units, it should be understood that in another embodiment, such percentages may also apply with respect to the weight percentages of each repeating unit within the copolymer.

Furthermore, the ratio of the moles of repeating unit (A) to the moles of repeating unit (B) may typically be controlled within a certain range. For instance, the ratio may be 0.001 or more, such as 0.01 or more, such as 0.05 or more, such as 0.1 or more, such as 0.2 or more, such as 0.5 or more, such as 0.6 or more, such as 0.8 or more, such as 1 or more. The ratio may be 10 or less, such as 8 or less, such as 5 or less, such as 4 or less, such as 3 or less, such as 2.5 or less, such as 2 or less, such as 1.7 or less, such as 1.5 or less, such as 1.4 or less, such as 1.2 or less, such as 1 or less.

The number average molecular weight of repeating unit (A) may be about 300 Daltons or more, such as about 500 Daltons or more, such as about 1,000 Daltons or more, such as about 2,000 Daltons or more, such as about 4,000 Daltons or more. The number average molecular weight of repeating unit (A) may be about 50,000 Daltons or less, such as about 25,000 Daltons or less, such as about 20,000 Daltons or less, such as about 15,000 Daltons or less, such as about 12,000 Daltons or less, such as about 10,000 Daltons or less, such as about 8,000 Daltons or less, such as about 6,000 Daltons or less. The number average molecular weight of repeating unit (B) may likewise be about 300 Daltons or more, such as about 500 Daltons or more, such as about 1,000 Daltons or more, such as about 2,000 Daltons or more, such as about 4,000 Daltons or more. The number average molecular weight of repeating unit (B) may be about 50,000 Daltons or less, such as about 25,000 Daltons or less, such as about 20,000 Daltons or less, such as about 15,000 Daltons or less, such as about 12,000 Daltons or less, such as about 10,000 Daltons or less, such as about 8,000 Daltons or less, such as about 6,000 Daltons or less. The number average molecular weight of the entire copolymer may be about 1,000 Daltons or more, such as about 2,000 Daltons or more, such as about 4,000 Daltons or more, such as about 6,000 Daltons or more, such as about 8,000 Daltons or more, such as about 10,000 Daltons or more, such as about 20,000 Daltons or more. The number average molecular weight of the entire copolymer may be about 100,000 Daltons or less, such as about 80,000 Daltons or less, such as about 60,000 Daltons or less, such as about 40,000 Daltons or less, such as about 30,000 Daltons or less, such as about 25,000 Daltons or less, such as about 20,000 Daltons or less, such as about 15,000 Daltons or less. However, it should be understood that the molecular weight may not necessarily be limited by the present invention. Furthermore, the molecular weight may be determined using techniques generally known in the art, such as gel permeation chromatography.

Of course, it should also be understood that other repeating units or constituents may also be present in the copolymer if so desired. For instance, the copolymer may contain another repeating unit (C) that is different than the repeating units (A) and/or (B). When employed, such repeating units typically constitute no more than about 20 mol. %, such as no more than about 10 mol. %, such as no more than about 5 mol %, such as no more than about 4 mol % to 0.1 mol % or more, such as 0.2 mol % or more, such as 0.5 mol % or more, such as 0.7 mol % or more, such as 1 mol % or more, such as 2 mol % or more of the copolymer. In one embodiment, the copolymer may not contain another repeating unit (C).

The acrylate copolymer may also possess any desired configuration, such as block (diblock, triblock, tetrablock, etc.), random, alternating, graft, star, etc. In one embodiment, the copolymer may have a random configuration. In another embodiment, the copolymer may have a block configuration. When block configurations are utilized, without intending to be limited by theory, the block oligomer segments may allow larger regions of the repeating units (A) and/or (B) to predominate throughout the polymer chain which may result in a more ordered structure that may improve various functions of the copolymer. For example, the ordered structure may increase the degree to which the copolymer can nucleate wax crystallization, interact with a paraffinic crystalline or asphaltene surface, thus increasing the percent wax inhibition and decreasing the asphaltene dispersancy parameter as described below. Furthermore, the organized structure may also be more stable at very low temperatures, which may enhance the ability of the resulting composition to flow at such temperatures, such as characterized by the no-flow point and static time to gel. As a result of its highly ordered structure, the copolymer may have a relatively high crystalline melting temperature, such as about 30° C. or more, such as about 40° C. or more, such as about 50° C. or more to about 300° C. or less, such as about 200° C. or less, such as about 150° C. or less, such as about 100° C. or less, such as about 80° C. or less, such as about 60° C. or less. The copolymer may also have a relatively low crystallization temperature, such as about 100° C. or less, such as about 50° C. or less, such as about 30° C. or less to about 5° C. or more, such as about 10° C. or more. Also, the copolymer may also have a relatively low glass transition temperature of about 100° C. or less, such as about 50° C. or less, such as about 30° C. or less to about 5° C. or more, such as about 10° C. or more. The melting temperature, crystallization temperature, and glass transition temperature may be determined using differential scanning calorimetry (DSC).

The acrylate copolymer may be formed using any known polymerization technique as is known in the art. Generally, the monomer for repeating unit (A) may be polymerized with the monomer for repeating unit (B). However, the manner in which the reaction occurs may depend in part on the type of copolymer that is being formed. For example, when forming a random acrylate copolymer, the monomers for forming repeating units (A) and (B) may be polymerized together. In other cases, it may be desirable to form a block copolymer. In this regard, it may be desirable to initially form a prepolymer prior to completing the polymerization process. For instance, the monomer used to form either of repeating unit (A) or (B) may be reacted to form a first oligomer. Such first oligomer may then be reacted with the monomer used to form the other repeating unit (A) or (B). Alternatively, a second oligomer may be formed from the monomer used to form the other repeating unit (A) or (B) and such second oligomer may be reacted with the first oligomer.

Furthermore, it should be understood that the acrylate copolymers can be synthesized using various conditions generally utilized in the art. For instance, the polymerization conditions may be such that promote polymerization and formation of the acrylate copolymer. In one embodiment, the polymerization may be a free radical polymerization. Also, in one embodiment, the acrylate copolymer as disclosed herein may be a non-crosslinked acrylate copolymer.

The polymerization may also require an initiator. Suitable polymerization initiators may include any of the conventional free radical forming compounds, individually or in a mixture. These compounds may include, but are not limited to, aliphatic azo compounds, diacyl peroxides, peroxy-dicarbonates, alkyl per-esters (e.g., tert-butyl peroxy-2-ethylhexanoate or tert-amyl peroxy-2-ethylhexanoate, etc.), alkyl hydroperoxides, per ketals, dialkyl peroxides (e.g., di-tert-butyl peroxide, di-tert-amyl peroxide, etc.), or ketone peroxides. The initiator may be provided in an amount to promote the free radical polymerization, such as in an amount of from 0.01 wt. % to 10 wt. % based on the amount of the comonomers.

In addition, the polymerization may be conducted in the presence of a polymerization inhibitor. For example, such inhibitor may be utilized to stabilize the polymerization and/or prevent polymerization under certain conditions. In addition, these inhibitors may be utilized to control the polymerization. These inhibitors may include, but are not limited to, 4-tert-butylpyrocatechol, tert-butylhydroquinone, 1,4-benzoquinone, 6-tert-butyl-2,4-xylenol, 2-tert-butyl-1,4-benzoquinone, 2,6-di-tert-butyl-p-cresol, 2,6-di-tert-butylphenol, 1,1-diphenyl-2-picrylhydrazyl, hydroquinone, 4-methoxyphenol, phenothiazine, or a mixture thereof. In one embodiment, the inhibitor may include 4-methoxyphenol. The amount of inhibitor utilized is not necessarily limited by the present invention.

As indicated above, the acrylate copolymer is formed by polymerizing the monomer for repeating unit (A) with the monomer for repeating unit (B). The monomer utilized in forming repeating unit (B) may be formed using various techniques. In particular, the monomer utilized in forming repeating unit (B) may be formed by reacting an acrylic acid with a compound including a glycidyl group. For example, such reaction may occur between the carboxyl group of the acrylic acid and the glycidyl group of the compound including a glycidyl group.

The acrylic acid is not necessarily limited by the present reaction. For instance, the acrylic acid may react with the compound including a glycidyl group and still have an opportunity to participate in (e.g., with the presence of an unsaturated carbon double bond) the polymerization with the monomer for repeating unit (A) to form the acrylate copolymer. In this regard, in one embodiment, the acrylic acid may be a methacrylic acid.

The compound including a glycidyl group may be any generally known in the art. In general, the compound may have an epoxy group content of 10 mmol/kg or more, such as 25 mmol/kg or more, such as 50 mmol/kg or more, such as 100 mmol/kg or more, such as 250 mmol/kg or more, such as 500 mmol/kg or more, such as 1,000 mmol/kg or more, such as 1,500 mmol/kg or more, such as 2,000 mmol/kg or more, such as 2,500 mmol/kg or more, such as 3,000 mmol/kg or more, such as 3,500 mmol/kg or more, such as 4,000 mmol/kg or more to 10,000 mmol/kg or less, such as 9,000 mmol/kg or less, such as 8,000 mmol/kg or less, such as 7,000 mmol/kg or less, such as 6,500 mmol/kg or less, such as 6,000 mmol/kg or less, such as 5,500 mmol/kg or less, such as 5,000 mmol/kg or less, such as 4,500 mmol/kg or less. In general, such epoxy group content is the ratio between the amount of epoxy (or glycidyl) groups to the molecular weight of the compound. This provides an indication of the number of moles of epoxy (or glycidyl) groups based on 1 kg of the compound.

In one particular embodiment, such compound may be a glycidyl ester, a glycidyl ether, a glycidyl amine, a glycidyl amide, or a mixture thereof. In one embodiment, such compound may include a glycidyl ester. In another embodiment, such compound may include a glycidyl ether. In a further embodiment, such compound may include a glycidyl amine. In another embodiment, such compound may include a glycidyl amide.

In one embodiment, such compound including a glycidyl group may include a glycidyl ester. For instance, the glycidyl ester may be an aliphatic glycidyl ester, an aromatic glycidyl ester, or a mixture thereof. In one embodiment, the glycidyl ester may be an aromatic glycidyl ester. In another embodiment, the glycidyl ester may be an aliphatic glycidyl ester. Also, such aliphatic group may be saturated or unsaturated. In one embodiment, such group may be saturated. In another embodiment, such group may be unsaturated. Also, such aliphatic group may be a straight chain or a branched chain. In one embodiment, such group may be a straight chain. In another embodiment, such group may be a branched chain.

The glycidyl ester may be of a carboxylic acid. Like the aliphatic group, such carboxylic acids may be straight chain or branched. The carboxylic acid may have 1 or more, such as 2 or more, such as 3 or more, such as 5 or more, such as 8 or more, such as 10 or more, such as 14 or more, such as 18 or more, such as 20 or more, such as 24 or more, such as 30 or more carbon atoms. The carboxylic acid may have 50 or less, such as 46 or less, such as 42 or less, such as 40 or less, such as 38 or less, such as 34 or less, such as 30 or less, such as 26 or less, such as 22 or less, such as 18 or less, such as 14 or less, such as 12 or less, such as 10 or less carbon atoms.

The carboxylic acid may be a primary carboxylic acid, a secondary carboxylic acid, or a tertiary carboxylic acid. In one embodiment, the carboxylic acid is a primary carboxylic acid. In another embodiment, the carboxylic acid is a secondary carboxylic acid. In a further embodiment, the carboxylic acid is a tertiary carboxylic acid. In this regard, the carboxylic acid may be a straight chain carboxylic acid or a branched carboxylic acid. In one embodiment, the carboxylic acid is a straight chain carboxylic acid. In another embodiment, the carboxylic acid is a branched carboxylic acid.

The carboxylic acid may be acetic acid, propionic acid, butanoic acid, pentanoic acid, hexanoic acid, heptanoic acid, octanoic acid, nonanoic acid, decanoic acid (e.g., neodecanoic acid), undecanoic acid, dodecanoic acid, tridecanoic acid, tetradecanoic acid, pentadecanoic acid, hexadecanoic acid, heptadecanoic acid, octadecanoic acid, nonadecanoic acid, icosanoic acid, and the like. In this regard, in one embodiment, the carboxylic acid may be a saturated carboxylic acid. However, it should be understood that even longer chain carboxylic acids may be utilized.

In one particular embodiment, the carboxylic acid may be a decanoic acid. In particular, the carboxylic acid may be a neodecanoic acid. For instance, the carboxylic acid may include a mixture of carboxylic acids. In particular, the carboxylic acid may be trialkyl carboxylic acids. The trialkyl carboxylic acids may have alkyl groups at the 2 position. Examples of such trialkyl carboxylic acids include, but are not limited to, 2,2,3,5-tetramethylhexanoic acid, 2,4-dimethyl-2-isopropylpentanoic acid, 2,5-dimethyl-2-ethylhexanoic acid, 2,2-dimethyloctanoic acid, and 2,2-diethylhexanoic acid.

In one embodiment, the carboxylic acid may be a fatty acid such that the glycidyl ester is a fatty acid glycidyl ester. For example, such fatty acid may have 12 or more, such as 14 or more, such as 16 or more, such as 18 or more, such as 20 or more, such as 22 or more, such as 24 or more, such as 26 or more, such as 30 or more carbon atoms. The fatty acid may have 48 or less, such as 44 or less, such as 40 or less, such as 36 or less, such as 32 or less, such as 30 or less, such as 28 or less, such as 26 or less, such as 24 or less carbon atoms.

In addition, it should be understood that these carboxylic acids may include one or more substituent groups. In particular, in one embodiment, these carboxylic acids may include at least two, such as at least three substituent groups. In general, the carboxylic acids may have a hydrogen replaced with an alkyl group. The alkyl group may be a methyl, ethyl, propyl (e.g., n-propyl, isopropyl), butyl (e.g., n-butyl), pentyl, hexyl, heptyl, octyl, nonyl, decyl, and the like. These substituent groups may themselves independently be straight chain or branched chain. In one embodiment, the substituent group may be a straight chain. In another embodiment, the substituent group may be a branched chain.

In one embodiment, such compound including a glycidyl group may include a glycidyl ether. For instance, the glycidyl ether may be an alkyl glycidyl ether. The alkyl of such glycidyl ether may be a C₁-C₄₀ alkyl. In this regard, the alkyl may be a C₁-C₄₀ alkyl, such as a C₁-C₃₀ alkyl, such as a C₁-C₂₀ alkyl, such as a C₁-C₁₄ alkyl, such as a C₁-C₁₀ alkyl, such as a C₂-C₈ alkyl, such as a C₂-C₆ alkyl. For instance, the alkyl may have 1 or more, such as 2 or more, such as 3 or more, such as 4 or more, such as 5 or more, such as 6 or more, such as 8 or more, such as 10 or more, such as 11 or more, such as 12 or more carbon atoms. The alkyl may have 40 or less, such as 30 or less, such as 20 or less, such as 15 or less, such as 14 or less, such as 12 or less, such as 10 or less, such as 8 or less, such as 6 or less, such as 4 or less carbon atoms. In addition, the alkyl may be a straight chain, a branched chain, or cyclic. In one embodiment, the alkyl is a straight chain. In another embodiment, the alkyl is a branched chain. In a further embodiment, the alkyl is cyclic.

The glycidyl ether may include, but is not limited to an allyl glycidyl ether, an ethyl glycidyl ether, a propyl glycidyl ether (e.g., an isopropyl glycidyl ether), a butyl glycidyl ether, a pentyl glycidyl ether, a hexyl glycidyl ether, a heptyl glycidyl ether, an octyl glycidyl ether, a 2-ethylhexyl glycidyl ether, a nonyl glycidyl ether, a decyl glycidyl ether, a dodecyl glycidyl ether, a tetradecyl glycidyl ether, a hexadecyl glycidyl ether, a phenyl glycidyl ether, a benzyl glycidyl ether, a napthyl glycidyl ether, a 4-nonylphenyl glycidyl ether, a 2-methylpentyl glycidyl ether, a 2-biphenylyl glycidyl ether, a 2-methylphenyl glycidyl ether, or a mixture thereof. In one embodiment, the glycidyl ether may be a butyl glycidyl ether, such as iso-butyl glycidyl ether, a tert-butyl glycidyl ether, an n-butyl glycidyl ether, or a mixture thereof. In one particular embodiment, the glycidyl ether may be n-butyl glycidyl ether.

Regardless of such compound, the compound including a glycidyl group may be reacted with an acrylic acid in a certain amount. For instance, the compound may be reacted in an amount of from 0.05 to 1.0 molar equivalents (meq) based on the moles of acrylic acid. For instance, the amount may be 0.05 or more, such as 0.1 or more, such as 0.2 or more, such as 0.3 or more, such as 0.4 or more, such as 0.5 or more. The molar equivalents may be 1.0 or less, such as 0.9 or less, such as 0.8 or less, such as 0.7 or less, such as 0.6 or less, such as 0.5 or less, such as 0.4 or less, such as 0.3 or less.

In addition, the monomer of repeating unit (B) can be synthesized using various conditions generally utilized in the art and is thus not limited by the present invention. For instance, such reaction may be conducted in a liquid phase. The liquid may be an organic liquid and is not necessarily limited by the present invention. In one embodiment, the compound including a glycidyl group itself may be in a liquid form and serve as the solvent for conducting the reaction such that a further solvent may not be necessary.

The reaction may be conducted at a temperature greater than room temperature, such as 25° C. or more, such as 50° C. or more, such as 75° C. or more, such as 100° C. or more, such as 125° C. or more. The temperature may be 300° C. or less, such as 250° C. or less, such as 225° C. or less, such as 200° C. or less, such as 150° C. or less, such as 125° C. or less. The reaction may also be conducted in the presence of an inert gas, such as argon and/or nitrogen.

In addition, the reaction may be conducted in the presence of a polymerization inhibitor. For example, such inhibitor may be utilized to stabilize the polymerization and/or prevent polymerization under certain conditions. In addition, these inhibitors may be utilized to control the polymerization. These inhibitors may include, but are not limited to, 4-tert-butylpyrocatechol, tert-butylhydroquinone, 1,4-benzoquinone, 6-tert-butyl-2,4-xylenol, 2-tert-butyl-1,4-benzoquinone, 2,6-di-tert-butyl-p-cresol, 2,6-di-tert-butylphenol, 1,1-diphenyl-2-picrylhydrazyl, hydroquinone, 4-methoxyphenol, phenothiazine, or a mixture thereof. In one embodiment, the inhibitor may include 4-methoxyphenol. The amount of inhibitor utilized is not necessarily limited by the present invention.

In addition, the reaction may be conducted in the presence of a quaternary ammonium or a salt thereof. The quaternary ammonium may be an alkyl quaternary alkyl ammonium, such as a tetraalkylammonium. For example, the quaternary ammonium may include, but is not limited to, a tetramethylammonium, a tetramethylammonium, a tetrapropylammonium, a tetrabutylammonium, etc. The salt may be any as typically utilized in the art. For example, the salt may be a halide. In particular, the halide may be a chloride or a bromide.

The monomer utilized in forming repeating unit (A) may also be formed using various techniques. In particular, the monomer utilized in forming repeating unit (A) may be formed by reacting an acrylic acid with a compound including a hydroxyl group. For example, such reaction may occur between the carboxyl group of the acrylic acid and the hydroxyl group of the compound including a hydroxyl group.

The acrylic acid is not necessarily limited by the present reaction. For instance, the acrylic acid may react with the compound including a hydroxyl group and still have an opportunity to participate in (e.g., with the presence of an unsaturated carbon double bond) the polymerization with the monomer for repeating unit (B) to form the acrylate copolymer. In this regard, in one embodiment, the acrylic acid may be a methacrylic acid.

The compound including a hydroxyl group may be an alkyl, an alkenyl, or an alkynyl. In particular, such compound may include a C₈-C₅₀ alkyl, a C₈-C₅₀ alkenyl, or a C₈-C₅₀ alkynyl similar to the R₃ group mentioned above. In one particular embodiment, such compound including a hydroxyl group may include a C₈-C₅₀ alkyl.

In addition, the monomer of repeating unit (A) can be synthesized using various conditions generally utilized in the art and is thus not limited by the present invention. For instance, such reaction may be conducted in a liquid phase. The liquid may be an organic liquid and is not necessarily limited by the present invention. In one embodiment, the compound including a hydroxyl group itself may be in a liquid form and serve as the solvent for conducting the reaction such that a further solvent may not be necessary.

The reaction may be conducted at a temperature greater than room temperature, such as 25° C. or more, such as 50° C. or more, such as 75° C. or more, such as 100° C. or more, such as 125° C. or more. The temperature may be 300° C. or less, such as 250° C. or less, such as 225° C. or less, such as 200° C. or less, such as 150° C. or less, such as 125° C. or less. The reaction may also be conducted in the presence of an inert gas, such as argon and/or nitrogen.

As indicated above, the acrylate copolymer may be formed by polymerizing the monomer for repeating unit (A) with the monomer for repeating unit (B). In one embodiment, the monomer for repeating (A) may be combined with the monomer for repeating unit (B) and thereafter polymerized. In this regard, such monomers may be synthesized independently, for example not in the presence of the other monomer.

However, in another embodiment, at least one of the monomers may be synthesized in the presence of the other monomer. For example, the monomer for repeating unit (B) may be synthesized in the presence of the monomer for repeating unit (A). In particular, the reaction between the acrylic acid and the compound including a glycidyl group may occur in the presence of the monomer for forming repeating unit (A). Polymerization may then occur during or after the synthesis of the monomer for repeating unit (B). In one embodiment, polymerization may continue to occur while the monomer for repeating unit (B) is being synthesized such that the two reactions are occurring simultaneously.

While the aforementioned may describe a manner for forming the repeating unit (A), the repeating unit (B), and the acrylate copolymer, it should be understood that other methods generally known in the art may also be utilized for such syntheses.

Regardless of the particular manner in which it is formed, the acrylate copolymer may be utilized in various applications. For example, the acrylate copolymer may be utilized to modify a petroleum source. In this regard, in one embodiment, the acrylate copolymer may be employed at a concentration of 1 ppm or more, such as 2 ppm or more, such as 5 ppm or more, such as 10 ppm or more, such as 25 ppm or more, such as 50 ppm or more, such as 100 ppm or more, such as 250 ppm or more, such as 500 ppm or more, such as 1,000 ppm or more, such as 2,000 ppm or more, such as 2,500 ppm or more, such as 3,000 ppm or more, such as 5,000 ppm or more to 10,000 ppm or less, such as 9,000 ppm or less, such as 7,500 ppm or less, such as 6,000 ppm or less, such as 5,000 ppm or less, such as 3,000 ppm or less, such as 2,500 ppm or less, such as 2,000 ppm or less, such as 1,500 ppm or less, such as 1,200 ppm or less, such as 1,000 ppm or less, such as 500 ppm or less based on the combined weight of the copolymer and the petroleum source. The petroleum source may be a source of crude oil, another unrefined petroleum source, or a product derived therefrom, such as heating oil, fuel oil, bunker C oil, bitumen, etc.

The particular manner in which the acrylate copolymer is added to a petroleum source may vary. If desired, the copolymer may be employed in the form of a concentrated composition that contains the acrylate copolymer as the primary ingredient. In other embodiments, the copolymer may be employed in a composition that is in the form of a dispersion or solution that contains one or more solvents in combination with the copolymer. Dilution may occur prior to use, or it may also occur in the field by an end user of the composition.

In this regard, the composition may be a paraffin inhibitor composition. Such composition may include the copolymer mentioned above and containing both repeating units (A) and (B).

When employing the copolymer in a composition, a solvent may also be utilized. Suitable solvents may include organic solvents, such as aliphatic and/or aromatic hydrocarbons. Particularly suitable solvents include, for instance, petroleum-based solvents that include refined petroleum distillates or solvents. Refined petroleum distillates or solvents may include, for instance, aromatic compounds, such as benzene, toluene, xylene, light aromatic naphtha, heavy aromatic naphtha (HAN), kerosene, etc.; aliphatic compounds, such as pentane, hexane, heptane, octane, nonane, decane, undecane, dodecane, tridecane, tetradecane, pentadecane, hexadecane, etc.; as well as mixtures thereof. Naphtha is a petrochemical industry term describing boiling point fractions of petroleum distillate collected at different points on a distillation column. Naphtha fractions may include linear or branched or cyclic alkanes or alkenes, aromatic hydrocarbons, or fused ring aromatic compounds or mixtures of these materials. Light naphtha is a lower boiling material that is collected near the top portion of the distillation column. Medium naphtha is a higher boiling material that is collected from near the middle of the column. Finally, heavy naphtha is an even higher boiling material that is collected from near the bottom portion of the column. When solvents are employed, they may constitute 10 wt. % or more, such as 20 wt. % or more, such as 30 wt. % or more, such as 40 wt. % or more, such as 50 wt. % or more, such as 60 wt. % or more to 99 wt. % or less, such as 95 wt. % or less, such as 90 wt. % or less, such as 80 wt. % or less of the composition. Likewise, acrylate copolymer(s), such as described herein, may constitute 0.5 wt. % or more, such as 1 wt. % or more, such as 2 wt. % or more, such as 5 wt. % or more, such as 10 wt. % or more to 99 wt. % or less, such as 95 wt. % or less, such as 90 wt. % or less, such as 80 wt. % or less, such as 70 wt. % or less, such as 50 wt. % or less, such as 40 wt. % or less of the composition.

In addition to an acrylate copolymer and solvent, the composition may also contain one or more additional ingredients as is known in the art. These ingredients may include corrosion inhibitors, surfactants, dispersants, neutralizers, stabilizers, plasticizers, biocides, preservatives, etc. Suitable corrosion inhibitors may include, for instance, sulfonates, imidazolines, amines, amides, esters, as well as salts and/or polymers thereof. Examples of amine corrosion inhibitors may include n-tetradecyl amine, n-hexadecylamine, lauryl amine, myristyl amine, palmityl amine, stearyl amine, and oleyl amine, etc. When employed, an additional ingredient may be combined with the acrylate copolymer at any point after it is formed. For instance, an additional ingredient may be combined with the copolymer after it is diluted with a solvent or it may be simultaneously added as the copolymer is being formed. Likewise, the additional ingredients may be added at a single point in time or combined with the copolymer in the field to form the composition, such as in response to a certain environmental condition. As an example, one or more additional ingredients may be combined with the acrylate copolymer just prior to transportation or storage, or even just prior to the addition of the copolymer to crude oil.

One example of a suitable additional ingredient is a surfactant, which may be employed in an amount of from about 0.1 wt. % to about 10 wt. %, and in some embodiments, from about 0.2 wt. % to about 1 wt. % of the composition. Suitable surfactants may include nonionic surfactants, amphoteric surfactants, and/or anionic surfactants. Examples of suitable nonionic surfactants may include, for instance, alkoxylated alcohols, such as copolymers of ethylene oxide and/or propylene oxide and/or butylene oxide and epoxylated, propoxylated, and epoxylated-propoxylated compounds formed from C₆-C₄₀ alkanols. Other nonionic surfactants may also be employed, such as acrylate alkoxylates (e.g., nonylphenol ethoxylate), block copolymers of ethylene, propylene and butylene oxides, alkyl polyglucosides, polyalkoxylated glycerides, sorbitan esters and polyalkoxylated sorbitan esters, and alkoyl polyethylene glycol esters and diesters. Examples of suitable amphoteric surfactants may include alkyl dimethyl amine oxides, alkyl-bis(2-hydroxyethyl) amine oxides, alkyl amidopropyl dimethyl amine oxides, alkylamidopropyl-bis(2-hydroxyethyl) amine oxides, betaines, sultaines, alkyl amphoacetates and amphodiacetates, alkyl amphopropionates and amphodipropionates, dodecylbenzene sulfonic acid, and alkyliminodipropionate. Likewise, examples of suitable anionic surfactants may include alkylbenzene sulfonates, alkyldiphenoxyether sulfonates and disulfonates, napthalene sulfonates, linear and branched alkyl sulfonates, fatty alcohol sulfates, fatty alcohol ether sulfates, linear and branched alpha olefin sulfonates.

When utilized, the polymer composition containing the acrylate copolymer, solvent(s), and other optional components may be combined with a petroleum source in an amount of 1 ppm or more, such as 2 ppm or more, such as 5 ppm or more, such as 10 ppm or more, such as 15 ppm or more, such as 25 ppm or more, such as 50 ppm or more, such as 100 ppm or more, such as 250 ppm or more, such as 500 ppm or more, such as 1,000 ppm or more, such as 2,000 ppm or more, such as 2,500 ppm or more, such as 3,000 ppm or more, such as 5,000 ppm or more to 10,000 ppm or less, such as 9,000 ppm or less, such as 8,000 ppm or less, such as 6,000 ppm or less, such as 5,000 ppm or less, such as 3,000 ppm or less, such as 2,500 ppm or less, such as 2,000 ppm or less, such as 1,800 ppm or less, such as 1,500 ppm or less, such as 1,200 ppm or less, such as 1,000 ppm or less, such as 500 ppm or less based on the combined weight of the petroleum source and the polymer composition. The polymer composition may be added to the petroleum source in a variety of different ways to form a petroleum composition, such as during storage and/or transportation of a petroleum source. For example, the polymer composition may be readily poured or pumped from a storage container or vessel into contact with a petroleum source. The polymer composition can be stored within a container for at least some period of time, removed from the container, and then applied to the petroleum source. The duration of storage may vary from about 1 day to five years, such as about 2 days to 1 year, or about 1 week to 6 months, or about 2 weeks to 4 months, or about 1 to 2 months. The method of applying the polymer composition to the petroleum source is not particularly limited and can be conventionally added by using available equipment, such as pipes, mixers, pumps, tanks, injection ports, etc. In some embodiments, the polymer composition is applied to one or more subterranean hydrocarbon recovery (oil well) locations, such as downhole or on the backside using capillary string, gas lift, slip stream or other methods, at the wellhead, or at any other point downstream of the reservoir. The polymer composition may also be employed in combination with umbilical drilling equipment.

As indicated herein, the acrylate copolymer may serve or exhibit various functions, such as paraffin inhibition in particular on a surface. In addition, the acrylate copolymer may be “multi-functional” in that it exhibits two or more beneficial functions when used with a petroleum source. For instance, the acrylate copolymer may also be capable of suspending crystallized paraffin in the oil phase to prevent settling/sludging/severe inhomogeneity.

In one embodiment, the copolymer may act as a paraffin inhibitor. According to a Cold Finger method, the composition may achieve a percent paraffinic wax deposition inhibition of about 20% or more, such as about 30% or more, such as about 40% or more, such as about 50% or more, such as about 55% or more, such as 60% or more, such as 70% or more, such as 80% or more to 100% or less, such as 99% or less, such as 97% or less, such as 95% or less, such as 93% or less, such as 90% or less, such as 85% or less for a given model oil fluid. Without intending to be limited by theory, the ability of the copolymer to function effectively at low temperatures is believed to be at least partially due to its ability to retain good solubility and flow properties at low temperatures. For example, the no-flow point of the copolymer may be relatively low, such as about 15° C. or less, such as about 10° C. or less, such as about 5° C. or less, such as about 0° C. or less, such as about −5° C. or less, such as about −10° C. or less, such as about −15° C. or less when determined in accordance with ASTM D-7346-15 and at a non-volatile residue percentage that may vary from 5% to 30% (e.g., 15%). In addition to simply performing well at low temperatures, good properties can be maintained at a cold temperature site without risking gel formation over a broad range of temperatures.

The copolymer may also exhibit further beneficial properties indicative of improved performance at low temperatures. For instance, the copolymer may allow for a reduction in the cloud point temperature thereby indicating a reduction in the temperature at which point a sample becomes relatively cloudy and begins to solidify. In this regard, with the acrylate copolymer as disclosed herein, the cloud point depression (ΔCP) may be at least 0.1° C., such as at least 0.2° C., such as at least 0.3° C., such as at least 0.5° C., such as at least 0.8° C., such as at least 1° C., such as at least 1.3° C., such as at least 1.5° C., such as at least 1.8° C., such as at least 2° C. when determined in accordance with ASTM D-5773 and the method disclosed herein. The cloud point depression (ΔCP) may be 4° C. or less, such as 3° C. or less, such as 2.5° C. or less, such as 2° C. or less, such as 1.5° C. or less, such as 1° C. or less, such as 0.8° C. or less, such as 0.5° C. or less when determined in accordance with ASTM D-5773 and the method disclosed herein. Such depression may be realized at least at one copolymer dosage of 2000 ppm, 1000 ppm, 500 ppm, or 250 ppm.

In addition or alternatively, the acrylate copolymer may be capable of preventing the formation of a paraffin gel network at sufficiently low temperatures, thereby reducing the pour point. For instance, with the acrylate copolymer as disclosed herein, the pour point depression (ΔPP) may be at least 0.5° C., such as at least 1° C., such as at least 2° C., such as at least 5° C., such as at least 8° C., such as at least 10° C., such as at least 15° C., such as at least 20° C. when determined in accordance with ASTM D-5949 and the method disclosed herein. The pour point depression (ΔPP) may be 60° C. or less, such as 50° C. or less, such as 40° C. or less, such as 35° C. or less, such as 30° C. or less, such as 25° C. or less, such as 20° C. or less, such as 15° C. or less, such as 13° C., such as 10° C. when determined in accordance with ASTM D-5949 and the method disclosed herein. Such depression may be realized at least at one copolymer dosage of 2000 ppm, 1000 ppm, 500 ppm, or 250 ppm.

### Test Methods

Cloud Point (CP) and Pour Point (PP): The following equipment was used for this test:

PhaseTechnology ASL-70Xi Autosampler Analyzer

The Phase Technology ASL-70Xi Autosampler Analyzer system is used to determine the cloud point (ASTM D5773) and pour point (ASTM D5949) of lube oils, fuels, and waxy paraffinic solutions. The cloud point and pour point were determined by following the ASTM methods developed and described for each test.

The cloud point and pour point tests are used to assess the ability of a sample to interact with the paraffinic components of a wax burdened fluid. The performance of any one sample is revealed by the measured depression of both the cloud point and pour point temperature relative to a blank untreated sample. Furthermore, a dose-response over a range of concentrations can provide additional evidence of the magnitude of the interaction between the sample and the paraffin in solution. Samples were prepared by dosing 1000 ppm of the test sample gravimetrically from 15% NVR stock solutions in A150 and mixing them with the required amount of preheated test fluids. The treated samples were conditioned in a temperature controlled oven set at 60-70° C. for a period of at least 4 hours before starting the cloud point and pour point tests. In each test, an untreated blank was run concomitantly with the test fluids treated with the experimental sample. All samples were compared against the average cloud point and pour point values for the untreated fluid. Based on the test procedure performed above, the cloud point depression (ΔCP) and pour point depression (ΔPP) for a given test sample may then be determined by subtracting the measured value of the test sample from the running average of the untreated blank.

No Flow Point: To perform this test, a Peltier stage was equilibrated to 40° C., the sample was loaded into a trim gap of 350 μm, and the sample was trimmed at a gap of 300 μm by drawing excess sample into a pipette. The sample was then conditioned by preheating to 80° C., holding for 600 seconds, and then initiating a preconditioning step in which the sample was sheared at a rate of 0.1 s⁻¹ for 150 seconds. The sample was then cooled to either 10° C. or 30° C. and then the oscillation temperature sweep was executed. Measurements were taken at 3° C. temperature steps with a stress of 0.4 Pa and an angular frequency of 0.25 rad/s. The reported value for the rheological no-flow-point was the temperature at which the oscillation displacement reached zero.

### EXAMPLES

The examples below demonstrate the synthesis of the acrylate copolymer as described herein.

### Example 1

This example demonstrated the synthesis of the UNILIN™ 350 acrylate monomer. For instance, a four-neck round bottom flask equipped with an overhead stirrer, a nitrogen inlet, a moisture trap, a condenser, and a bottom drain valve was charged with acrylic acid (115 g, 1.59 mol), UNILIN™ 350 alcohol (750 g, 1.63 mol), para-methoxyphenol (1.00 g, 0.00806 mol), para-toluenesulfonic acid (4.55 g, 0.0239 mol), and heptane (200 g). The contents of the flask were heated to 110° C. to azeotropically remove water of condensation. After 6 hours, 28.0 grams of water were removed azeotropically. The reaction mixture was cooled to 80° C. and washed with H₂O (2×100 g) and each time the contents were heated to between 80-90° C. with stirring before allowing the layers to separate and be removed. After washing, the reaction mixture was brought back to reflux and the residual water was removed by azeo distillation. The reaction mixture was then distilled up to a temperature of 130° C. to remove heptane after which the flask was charged with A150 (100 g) and heated to 120° C. to atmospherically remove any residual heptane. The product was cooled and used without any further purification. This method was used to prepare n-alkyl esters of acrylic and (meth)acrylic acids with a normal chain alcohol.

### Example 2

This example demonstrated the epoxidation of acrylic acid with neodecanoic glycidyl ester. For instance, a four-neck round bottom flask equipped with an overhead stirrer, a nitrogen inlet, and a condenser was charged with glycidyl neodecanoate (903 g, 3.95 mol) and heated to 90-92° C. Once at the temperature, the flask was charged with tetraethylammonium bromide (11.9 g, 0.0564 mol), para-methoxyphenol (0.400 g, 0.00322 mol), and then acrylic acid (285 g, 3.95 mol). The mixture was maintained at a temperature between 90-92° C. for 2 hours after which the reaction mixture was maintained at a temperature between 100-107° C. until the acid index of the reaction mixture was <5 mgKOH/g. Once achieved, the reaction mixture was cooled and used in subsequent reactions without further purification. The same procedure was used to prepare the (meth)acrylic acid derivative using glycidyl neodecanoate.

### Example 3

This example demonstrated the synthesis of the acrylate copolymer based on Examples 1 and 2. For instance, a four-neck round bottom flask equipped with an overhead stirrer, a nitrogen inlet, and a condenser was charged with the UNILIN™ 350 acrylate monomer from Example 1 (212 g, 0.420 mol), the product from Example 2 (95.9, 0.420 mol), xylenes (113 g), and n-dodecyl mercaptan (3.37 g, 0.0167 mol). A nitrogen atmosphere was introduced to the flask and the reaction mixture was heated to 50° C., after which a xylene solution (14.1 g) containing PERKADOX™ AMBN (0.310 g, 0.00161 mol) was added and the reaction mixture was then heated to between 120-122° C. After 3 hours had passed, another xylene solution (14.1 g) containing PERKADOX™ AMBN (0.310 g, 0.00161 mol) was added and the reaction mixture was maintained at 120-122° C. for an additional 3 hours. The reaction mixture was then cooled and used without further purification.

### Example 4

Following the procedure of Example 3, a range of copolymers was prepared with the monomers and at the monomer ratios defined in the table below. UL350A is the UNILIN™ 350 acrylate monomer of Example 1, UL425A is the UNILIN™ 425 acrylate monomer, UL350MA is the UNILIN™ 350 (meth)acrylate monomer, UL425MA is the UNILIN™ 425 (meth)acrylate monomer, p-ACE is the acrylate homopolymer of Example 2, m-ACE is an acrylate monomer including the glycidyl neodecanoate derivative of acrylic acid of Example 2, m-MACE is a (meth)acrylate monomer including a glycidyl neodecanoate derivative of (meth)acrylic acid.

In Table 1 below, Samples 1-9 represent comparative samples. For instance, these samples simply include a mixture of two polymers. The first polymer is based on UL350A and/or UL425A while the second polymer is based on a homopolymer formed from the monomer of Example 2. Meanwhile, Samples 10-21 are considered inventive samples including a copolymer containing either UL350A, UL425A, or UL350A and m-ACE or m-MACE.

TABLE 1
Sample Compositions

| Sample | UL350A | UL425A | UL350MA | UL425MA | p-ACE | m-ACE | m-MACE |
|---|---|---|---|---|---|---|---|
| 1 | 0.75 | — | — | — | 0.25 | — | — |
| 2 | 0.5 | — | — | — | 0.5 | — | — |
| 3 | 0.25 | — | — | — | 0.75 | — | — |
| 4 | — | 0.75 | — | — | 0.25 | — | — |
| 5 | — | 0.5 | — | — | 0.5 | — | — |
| 6 | — | 0.25 | — | — | 0.75 | — | — |
| 7 | 0.375 | 0.375 | — | — | 0.25 | — | — |
| 8 | 0.25 | 0.25 | — | — | 0.5 | — | — |
| 9 | 0.125 | 0.125 | — | — | 0.75 | — | — |
| 10 | 0.75 | — | — | — | — | 0.25 | — |
| 11 | 0.5 | — | — | — | — | 0.5 | — |
| 12 | 0.25 | — | — | — | — | 0.75 | — |
| 13 | — | 0.75 | — | — | — | 0.25 | — |
| 14 | — | 0.5 | — | — | — | 0.5 | — |
| 15 | — | 0.25 | — | — | — | 0.75 | — |
| 16 | — | — | 0.75 | — | — | — | 0.25 |
| 17 | — | — | 0.5 | — | — | — | 0.5 |
| 18 | — | — | 0.25 | — | — | — | 0.75 |
| 19 | — | — | — | 0.75 | — | — | 0.25 |
| 20 | — | — | — | 0.5 | — | — | 0.5 |
| 21 | — | — | — | 0.25 | — | — | 0.75 |

After synthesis, the cloud point and pour point as well as the cloud point depression (ΔCP) and the pour point depression (ΔPP) were determined. In addition, the no-flow point (NFP) was also determined. In the analysis, the model oil exhibited an average (of 17 samples) cloud point of 30.54° C. and an average pour point of 28° C. The model oil contained a mixture of a known concentration of a certain type of refined waxes dissolved in a 70%/30% by volume mixture of EXXSOL™ D60 (EXXONMOBIL™) and heavy aromatic naphtha 150 (A150). The exact composition of the model oil is provided in Table 2 below while the results are provided in Table 3 below.

TABLE 2
Model Oil Composition

| | wt. % | wt. % | Total wt. % |
|---|---|---|---|
| Fluid | Wax A | Wax B | waxes |
| Model | 5% WAKO ™ | 5% WAKO ™ | 10 |
| Oil 1 | 42-44 | 66-68 | |

TABLE 3
Cloud Point, Pour Point, and No-Flow Point Results

| | Cloud Point | Pour Point | ΔCP | ΔPP | NFP |
|---|---|---|---|---|---|
| Sample | (° C.) | (° C.) | (° C.) | (° C.) | (° C.) |
| 1 | 28.6 | 15 | 1.9 | 13 | 20 |
| 2 | 29.2 | 21 | 1.3 | 7 | 8 |
| 3 | 29.8 | 24 | 0.7 | 4 | <-15 |
| 4 | 30.2 | 24 | 0.3 | 4 | 35 |
| 5 | 30.4 | 27 | 0.2 | 1 | 32 |
| 6 | 30.5 | 27 | 0.0 | 1 | −1 |
| 10 | 28.6 | 15 | 2.0 | 13 | 14 |
| 11 | 29.4 | 18 | 1.1 | 10 | <-15 |
| 12 | 30.7 | 27 | −0.1 | 1 | <-15 |
| 13 | 29.6 | 18 | 1.0 | 10 | 17 |
| 14 | 29.6 | 21 | 0.9 | 7 | 11 |
| 15 | 30.6 | 27 | 0.0 | 1 | <-15 |
| 16 | 29.5 | 3 | 1.1 | 25 | −1 |
| 17 | 29.8 | 18 | 0.8 | 10 | <-15 |
| 18 | 31.1 | 27 | −0.5 | 1 | <-15 |
| 19 | 30.1 | 24 | 0.5 | 4 | 26 |
| 20 | 30.1 | 21 | 0.5 | 7 | <-15 |
| 21 | 30.6 | 27 | −0.1 | 1 | <-15 |
| Blank | 30.54 | 28 | — | — | — |
| Model Oil | | | | | |

As indicated in the table above, the inventive samples including the acrylate copolymer generally exhibited a lower no-flow point, thereby indicating better performance at lower temperatures, than the comparative samples simply including a mixture of two polymers.

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

1-35. (canceled)

36. An acrylate copolymer comprising the following repeating units (A) and (B): 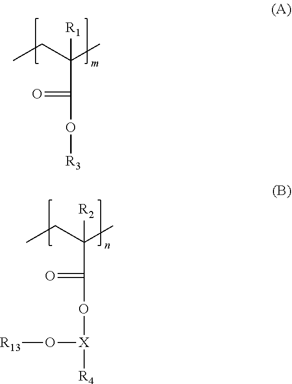
wherein,
R₁ and R₂ are each independently H or a C₁-C₂ alkyl;
R₃ is a C₈-C₅₀ alkyl, a C₈-C₅₀ alkenyl, or a C₈-C₅₀ alkynyl;
X is a divalent radical;
R₄ is a C₄-C₅₀ alkyl, a C₄-C₅₀ alkenyl, a C₄-C₅₀ alkynyl, a C₄-C₁₀ aryl, or —R₅-R₆;
wherein,
R₅ is —C(O)O—, —OC(O)—, —C(O)—, —C(O)N(R₁₀)—, —N(R₁₁)C(O)—, —N(R₁₂)—, or —O—;
R₆ is an alkyl, an alkenyl, or an alkynyl; and
R₁₀, R₁₁, and R₁₂ are each independently H, an alkyl, an alkenyl, or an alkynyl;
R₁₃ is H, an alkyl, an alkenyl, or an alkynyl;
m is an integer from 1 to 200; and
n is an integer from 1 to 200.

37. The acrylate copolymer of claim 36, wherein R₁ and R₂ are H.

38. The acrylate copolymer of claim 36, wherein at least one of R₁ and R₂ is a C₁ alkyl.

39. The acrylate copolymer of claim 36, wherein R₃ is a C₈-C₄₀ alkyl.

40. The acrylate copolymer of claim 36, wherein the divalent radical is an alkylene having from 2 to 6 carbon atoms.

41. The acrylate copolymer of claim 40, wherein the alkylene is an ethylene or propylene.

42. The acrylate copolymer of claim 36, wherein R₁₃ is H.

43. The acrylate copolymer of claim 36, wherein R₄ is a C₄-C₄₀ alkyl.

44. The acrylate copolymer of claim 36, wherein R₄ is —R₅-R₆.

45. The acrylate copolymer of claim 44, wherein R₅ is —OC(O)—.

46. The acrylate copolymer of claim 36, wherein the repeating unit (B) has the following formula: 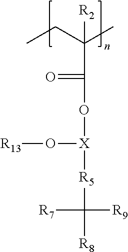
wherein,
R₇, R₈, and R₉ are each independently H, an alkyl, an alkenyl, or an alkynyl wherein at least one of R₇, R₈, and R₉ is not H.

47. The acrylate copolymer of claim 46, wherein at least one of R₇, R₈, and R₉ is an alkyl.

48. The acrylate copolymer of claim 46, wherein at least two of R₇, R₈, and R₉ are an alkyl including from 1 to 4 carbon atoms and at least one of R₇, R₈, and R₉ is an alkyl including from 5 to 10 carbon atoms.

49. The acrylate copolymer of claim 46, wherein R₇ and R₈ are methyl.

50. The acrylate copolymer of claim 46, wherein at least one of R₇ and R₈ is methyl and one of R₇ and R₈ is ethyl.

51. The acrylate copolymer of claim 36, wherein the ratio of the number of moles of repeating unit (A) to the number of moles of repeating unit (B) is from 1:10 to 10:1.

52. A paraffin inhibitor composition comprising the acrylate copolymer of claim 36.

53. The paraffin inhibitor composition of claim 52, further comprising a petroleum-based solvent wherein the petroleum-based solvent constitutes from about 10 wt. % to about 99 wt. % of the composition and the acrylate copolymer constitutes from about 1 wt. % to about 90 wt. % of the composition.

54. A petroleum composition comprising the paraffin inhibitor composition of claim 52 and a petroleum source

55. The petroleum composition of claim 54, wherein the acrylate copolymer is present in the petroleum composition in an amount of from about 10 ppm to about 10,000 ppm.

56. A method of synthesizing the acrylate copolymer of claim 36, the method comprising:
polymerizing the monomer for repeating unit (A) and the monomer for repeating unit (B),
wherein the monomer for repeating unit (B) is formed by reacting an acrylic acid with a compound including a glycidyl group.

57. The method of claim 56, wherein the compound including a glycidyl group comprises a glycidyl ester of a carboxylic acid.

58. The method of claim 57, wherein the carboxylic acid comprises a neodecanoic acid.

59. The method of claim 56, wherein the monomer for repeating unit (B) is formed in the presence of the monomer for repeating unit (A).
